(19) United States
(12) Patent Application Publication
(10) Pub. No.: US 2026/0318614 A1
(43) Pub. Date: Oct. 15, 2026

(54) LEAKAGE-RESISTANT PHASE CHANGE MATERIAL COMPOSITE FOR THERMAL MANAGEMENT

(71) Applicant: Northeastern University, Boston, MA (US)

(72) Inventors: Hongwei Sun, Lexington, MA (US); Xinrui Xiang, Boston, MA (US)

(21) Appl. No.: 19/643,228

(22) Filed: Apr. 9, 2026

Related U.S. Application Data
(60) Provisional application No. 63/785,799, filed on Apr. 9, 2025.

(51) Int. Cl. F28D 20/00; C08J 9/00; C08J 9/40; C09K 5/06; F28D 21/00

(52) U.S. Cl. CPC F28D 20/0056; C08J 9/0009; C08J 9/40; C09K 5/063; C08J 2205/04; F28D 2020/0017; F28D 2021/0028; F28D 2021/0035; F28D 2021/0042

(57) ABSTRACT

Disclosed are composite materials, comprising a porous material impregnated with a phase change mixture; wherein: the phase change mixture comprises a phase change material and a plurality of particles; and each particle in the plurality of particles comprises a core and a shell; wherein the core is within the shell; the core comprises the phase change material; and the shell comprises a polymer. Also disclosed is a method of making the composite materials and their application in thermal management systems for cold chain logistics and temperature-controlled transport, thermal management of power systems, energy storage of renewable energy systems, and passive cooling and heating of buildings.

### GOVERNMENT SUPPORT

This invention was made with government support under Grant Number N00014-20-1-2858 awarded by the U.S. Office of Naval Research. The Government has certain rights in the invention.

### RELATED APPLICATIONS

This application claims the benefit of priority to U.S. Provisional Application No. 63/785,799, filed Apr. 9, 2025.

### BACKGROUND

Phase change materials (PCMs) are widely used in many areas such as solar energy utilization, waste heat recovery, electronics cooling, battery thermal management. But the low thermal conductivity and leakage issues during phase changes hinder its widespread application. There is a need to develop PCMs that address these deficiencies.

### SUMMARY OF THE INVENTION

In some embodiments, the present disclosure relates to a composite material, comprising a porous material impregnated with a phase change mixture; wherein: the phase change mixture comprises a phase change material and a plurality of particles; and each particle in the plurality of particles comprises a core and a shell; wherein the core is within the shell; the core comprises the phase change material; and the shell comprises a polymer.

In some embodiments, the present disclosure relates to a method of making the composite material disclosed herein, comprising:
a) heating the phase change mixture to a temperature above its melting temperature, thereby producing a liquid phase change mixture;
b) contacting the porous material with the liquid phase change mixture; and
c) applying vacuum to the porous material, thereby producing the composite material.

In some embodiments, the present disclosure relates to a method of constructing a building capable of passive cooling or heating, comprising constructing the building using a building material, wherein the building material comprises the composite material of the disclosure.

In some embodiments, the present disclosure relates to a method of maintaining unchanging temperature of goods during transport, comprising transporting the goods in proximity to the composite material of the disclosure.

In some embodiments, the present disclosure relates to a method preventing overheating of a device, comprising contacting the device with the composite material of the disclosure.

In some embodiments, the present disclosure relates to a method of increasing efficiency of a device, comprising contacting the device with the composite material of the disclosure.

### BRIEF DESCRIPTION OF THE DRAWINGS

FIG. 1 is a schematic description of the procedure for composite phase change material (CPCM) fabrication and impregnation.

FIG. 2 is a plot demonstrating impregnation ratio of the foam based CPCMs.

FIGS. 3A and 3B show SEM images of I(a-d) octadecane-encapsulated microparticles (OEM) mixtures, II(a-d) Graphite foam (GF) based CPCM and III(a-d) Copper foam (CF) based CPCMs with mass fraction ranging from 0% to 30%.

FIGS. 3A and 3B show SEM images of I(e-g) octadecane-encapsulated microparticles (OEM) mixtures, II(e-g) Graphite foam (GF) based CPCM and III(e-g) Copper foam (CF) based CPCMs with mass fraction ranging from 40% to 60%.

FIG. 4 is a plot showing thermal conductivity of the OEM mixtures and foam based CPCMs of various mass fractions.

FIG. 5A shows plots demonstrating DSC curves and latent heat analysis of (a-b) Octadecane and OEM; (c-d) OEM mixtures.

FIG. 5B shows plots demonstrating DSC curves and latent heat analysis of (e-f) copper foam based CPCMs; and (g-h) graphite foam based CPCMs.

FIG. 6 is a plot showing analysis of supercooling behavior across various OEM mixture mass fractions.

FIG. 7 is a schematic diagram of the OEM mixture sample fabrication process.

FIG. 8 shows photographs demonstrating contact angle of OEM mixtures after liquefaction at mass fractions ranging from 0% to 60%.

FIG. 9 shows photographs demonstrating void areas after the fourth melting cycle of graphite foam (left) and copper foam (right) based CPCMs. The voids are highlighted with circles.

FIG. 10 shows plots demonstrating leakage ratio changes of CPCMs for (a) GF-CPCMs and (b) CF-CPCMs with mass fractions from 0 to 60% for 4 cycles; and leakage ratios of (c) GF-CPCM and (d) CF-CPCM at mass fraction of 60% over 20 cycles.

FIG. 11 is a schematic representation of the foam-based CPCM fabrication process and its accommodation of volume expansion during melting.

### DETAILED DESCRIPTION

Phase change materials (PCMs), recognized for their stability, superior temperature regulation, and excellent energy storage properties, have been extensively studied and applied across various fields. However, low thermal conductivity and leakage issues in melting/solidification cycles hinder its widespread application. In some embodiments, present disclosure relates to the development of a composite phase change material (CPCM) by incorporating octadecane (C18) and octadecane-encapsulated microparticles (OEM) into a graphite/copper foam through a vacuum impregnation process to overcome these issues. The results show that the thermal conductivity of copper foam-based CPCM can reach 2.17 W/m·K and 13.92 W/m·K for graphite foam-based CPCM, compared to 0.34 W/m·K of pure octadecane. The leakage study shows that the microparticle-PCM mixture exhibits solid-like behavior at the mass fraction of 60%, which effectively reduces the leakage ratio of PCM to 2.87% and 1.98% for graphite-foam based and copper-foam based CPCMs, respectively. The developed CPCM presents a cost-effective solution for achieving superior thermal conductivity, high latent heat storage, and exceptional leakage resistance, making it a promising material for thermal management applications.

Phase change materials (PCMs), featured by high energy storage capability and environmental friendliness, are widely used in renewable energy storage systems to address the growing energy crisis, such as in the areas of solar energy utilization and waste heat recovery [1]. Furthermore, the relatively stable phase transition temperature of PCMs promises a highly suitable capability for thermal management applications, ensuring optimal system performance in areas such as electronics cooling, battery thermal management [2-4] and metal hydride hydrogen storage [5]. However, the low thermal conductivity (e.g., paraffin: 0.22 W/m·K) [6] and leakage issues during phase change processes [7] present significant challenges, limiting their broader adoption.

Various strategies have been proposed and implemented to enhance thermal properties. Approaches such as integrating fin structures, nanoparticles, expanded graphite (EG), and porous foam with PCM have been widely studied to improve thermal conductivity [8-10]. To improve the thermal performance of PCM with a low thermal conductivity of 0.22 W/m·K, Akula et al. incorporated fins on heat transfer enhancement, finding that using 260 fins resulted in a 15.7° C. temperature reduction compared to a heat sink without fins under a 5 C discharge rate in a battery thermal management system (BTMS). Han et al. found that incorporating 3 vol % Al₂O₃ nanoparticles into RT82, which has a thermal conductivity of 0.2 W/m·K, accelerated the melting process by 15% under a constant temperature. Yu et al. designed a paraffin/expanded graphite composite to increase thermal conductivity from 0.23 W/m·K for pure paraffin to 5.29 W/m·K and 7.82 W/m·K along the pressure and lamellar directions. Recently, to pursue higher thermal performance in PCM-based thermal management systems, metal foams, due to their porous structures and high thermal conductivity, are regarded as effective solutions for enhancing PCM thermal performance [14-15]. Elshaer et al. impregnated PCM into copper foam and demonstrated that increasing the pores per inch (PPI) significantly enhanced the contact area between the PCM and the foam, thereby improving thermal performance and reducing the maximum temperature. Sun et al. reported that a copper foam-based CPCM effectively mitigated the rapid temperature rise in the battery, reducing the maximum cell temperature from 57.4° C. to 51.4° C. under a 3C discharge rate. Muhammad et al. found that reducing copper foam porosity from 97% to 94%, which resulted in smaller and denser foam cells and shortened PCM solidification and melting times by up to 50% and 57%, respectively. Yu et al. developed a copper foam/single-walled carbon nanotube/paraffin composite which increased the thermal conductivity up to 2.22 W/m·K. To achieve even higher thermal conductivity while maintaining low weight, carbon and graphite foam, characterized by their low density and exceptionally high bulk thermal conductivity, has been extensively studied for improving the thermal conductivity of PCMs [20-22]. Li et al. synthesized carbon foam, carbon nanotubes, and octadecanol into CPCM, achieving a 403.8% increase in thermal conductivity compared to pure octadecanol. Yang et al. enhanced the thermal conductivity to 19.27 W/m·K by incorporating paraffin into graphite foam, compared to just 0.25 W/m·K for pure paraffin. Although CPCMs and foam-based PCMs have been widely studied to improve thermal conductivity [25], the leakage of PCM during phase change and potential presence of empty pores within the foam structure which may result in reduced energy storage capacity and need further investigation [26-27].

Various technologies and materials, such as resins and powders, have been explored to prevent PCM leakage [28-29]. Jiang et al. developed a CPCM using binary sulfates (Na₂SO₄—K₂SO₄) with coal fly ash as a supporting skeleton. After sintering, the composite exhibited effective leakage prevention, a thermal conductivity of 0.61 W/m·K, and a latent heat capacity of 60.43 J/g. Zhang et al. blended ethylene-propylene-diene monomer, EG, and paraffin wax into CPCM which can achieve complete leakage prevention and thermal conductivity of 2.52 W/m·K and a latent heat of 112.4 J/g. Palraj et al. developed a form-stable CPCM by mixing water, resins, and resinous materials, followed by processing with bentonite clay and graphite. The results indicated that bentonite encapsulated up to 45% of the NCPCM without leakage, achieving a thermal conductivity of 0.788 W/m·K. Kumar et al. developed a form-stable PCM by impregnating polyethylene glycol 400 into sea almond shell-derived activated carbon, resulting in a thermal conductivity of 0.411 W/m·K, a latent heat capacity of 26.53 J/g, and effective leakage prevention. Ma et al. combined expanded graphite with paraffin wax and coated the mixture with epoxy resin, achieving anisotropic thermal conductivities of 9.03 W/m·K and 5.58 W/m·K, and a leakage rate of 2.95%. However, Nair et al. reported that even with the addition of 25% expanded graphite to paraffin (RT55), leakage still occurred. Moreover, after multiple thermal cycles, significant phase segregation was observed, resulting in substantial paraffin leakage and crack formation. Foam-based composites, known for their lightweight properties and high thermal conductivity, have also been extensively studied for leakage prevention [36-37]. Xie et al. impregnated a paraffin/high-density polyethylene/expandable graphite composite into copper foam, achieving 3.414 W/m·K in thermal conductivity and effective leakage prevention, though with a significantly reduced latent heat capacity of 60 J/g. Mei et al. designed a dual-scale carbon foam impregnated with stearic acid, demonstrating no leakage, a stearic acid weight ratio of 78.61%, a thermal conductivity of 1.093 W/m·K, and a latent heat capacity of 171.9 J/g. Nishad et al. infiltrated paraffin into graphite foam and encapsulated it with the epoxy resin to avoid leakage and achieved a thermal conductivity of 2.15 W/m·K and a latent heat capacity of 138.1 J/g. Liu et al. fabricated graphite/PVA foam from an aqueous dispersion and integrated it with polyethylene glycol, producing a composite with strong mechanical properties, effective leakage prevention, a thermal conductivity of 3.48 W/m·K, and a latent heat capacity of 136.8 J/g.

Table 1 summarizes the existing PCM based technologies and their thermal conductivity, latent heat, and leakage behavior. Development of a CPCM with high thermal conductivity and latent heat and effective leakage prevention remains a significant challenge.

TABLE 1
Overview of studies conducted by various researchers on CPCM

| | | Thermal | Latent | |
|---|---|---|---|---|
| | | Conductivity | Heat | Leakage |
| Reference | Materials | (W/m · K) | (J/g) | Behavior |
| X. K. Yu et al. | OP44E/SWCNT/ | 2.22 | 168.65 | Yes |
| [19] | Copper foam | | | |
| C. Pan et al. | Erythritol/GA/ | 2.705 | 179.32 | No |
| [29] | Copper foam | | | |
| T. Jiang et al. | Na₂SO₄—K₂SO₄/ | 0.61 | 60.43 | No |
| [30] | coal fly ash | | | |
| M. Zhang et al. | EPDM/EG/PW | 2.52 | 112.4 | No |
| [31] | | | | |
| K. Palraj et al. | Bentonite clay/ | 0.788 | 243.54 | No |
| [32] | Graphite powder/ | | | |
| | NCPCM | | | |
| P. Kumar et al. | PEG 400/SASACF | 0.411 | 26.53 | No |
| [33] | | | | |
| F. Ma et al. | PW/EG/ER | 5.58 | 179.7 | Slightly |
| [34] | | | | |
| A. M. Nair et | RT55/EG | 4.92 | 121.87 | Yes |
| al. [35] | | | | |
| Y. Zhou et al. | Stearic acid/carbon | 3.15 | 176.6 | No |
| [37] | foam | | | |
| Y. Xie et al. | Paraffin/ | 3.414 | 60 | Slightly |
| [38] | polyethylene/ | | | |
| | graphite/Copper | | | |
| | foam | | | |
| W. Mei et al. | Carbon foam/stearic | 1.093 | 171.9 | Slightly |
| [39] | acid | | | |
| S. Nishad et | PW/graphite foam | 2.15 | 138.1 | No |
| al. [40] | | | | |
| M. Liu et al. | Graphite/PVA foam/ | 3.48 | 136.8 | No |
| [41] | polyethylene glycol | | | |

In some embodiments, the present disclosure relates to the development of a CPCM by impregnating graphite and copper foams with various mass fractions of octadecane and octadecane-encapsulated microparticles (OEM) mixture to achieve significant improvement in thermal conductivity but low in leakage. The microstructures of the octadecane/particle mixtures and foam-based CPCMs were analyzed using SEM. The thermal properties of CPCMs with different particle mass fractions in octadecane were evaluated in terms of thermal conductivity and latent heat. The leakage of CPCM was studied by observing shape changes of solid OEM mixture while melting under heating.

Described herein is an innovative synthesizing technology that significantly improves the thermal conductivity of PCMs, and prevents leakage issues during phase changes. The PCMs described herein exhibit 50-fold improvement in thermal conductivity, and are free of leakage when the PCMs change temperature from 20° C. to 150° C.

In some embodiments, the PCMs described herein may be applied in battery thermal management and electronic cooling (e.g., in the electric vehicle industry).

In some embodiments, the PCMs described herein may be applied to cold chain logistics & temperature-controlled transport: the PCMs can be used to keep food, beverages, and pharmaceuticals within specific temperature ranges for long durations without active energy supply.

In some embodiments, the PCMs described herein may be applied to thermal management of power systems such as electronics, batteries: the PCMs can be used to absorb heat spikes in these systems and protect them from overheating.

In some embodiments, the PCMs described herein may be applied to energy storage of renewable energy systems such as solar thermal energy plants: the PCMs can be integrated in solar water heaters, solar stills, and photovoltaic thermal (PVT) systems increases efficiency by storing excess heat, improving overall energy production.

In some embodiments, the PCMs described herein may be applied to buildings and construction (passive cooling & heating): the PCMs can be integrated into building materials like plasterboard, concrete, and insulation to reduce heating/cooling loads and maintain thermal comfort by absorbing excess heat during the day and releasing it at night.

### Definitions

For convenience, certain terms employed in the specification, examples, and appended claims are collected here.

As used herein, the singular forms “a,” “an” and “the” are intended to include the plural forms as well, unless the context clearly indicates otherwise.

The term “about” means within an acceptable error range for the particular value as determined by one of ordinary skill in the art, which will depend in part on how the values measured or determined, i.e., the limitations of the measurement system. Where the terms “about” or “approximately” are used in the context of compositions containing amounts of ingredients or conditions such as temperature, these values include the stated value with a variation of 0-10% around the value (X±10%).

Ranges are stated in shorthand to avoid having to set out at length and describe each and every value within the range. Therefore, when ranges are stated for a value, any appropriate value within the range can be selected, and these values include the upper value and the lower value of the range. For example, a range of two to thirty represents the terminal values of two and thirty, as well as the intermediate values between two to thirty, and all intermediate ranges encompassed within two to thirty, such as two to five, two to eight, two to ten, etc.

In some embodiments, the present disclosure relates to a composite material, comprising a porous material impregnated with a phase change mixture; wherein: the phase change mixture comprises a phase change material and a plurality of particles; and each particle in the plurality of particles comprises a core and a shell; wherein the core is within the shell; the core comprises the phase change material; and the shell comprises a polymer.

In some embodiments, the porosity of the porous material is greater than about 70%, is greater than about 75%, is greater than about 80%, is greater than about 85%, is greater than about 90%, or is greater than about 95%. In some embodiments, the porosity of the porous material is greater than about 70%.

In some embodiments, the porosity of the porous material is about 50%, about 55%, about 60%, about 65%, about 70%, about 75%, about 80%, about 85%, about 90%, or about 95%. In some embodiments, the porosity of the porous material is about 90%.

In some embodiments, the mean pore size of the porous material is about 1000 μm to about 1500 μm, about 1050 μm to about 1500 μm, 1100 μm to about 1500 μm, about 1150 μm to about 1500 μm, 1200 μm to about 1500 μm, about 1250 μm to about 1500 μm, 1300 μm to about 1500 μm, about 1350 μm to about 1500 μm, 1400 μm to about 1500 μm, about 1450 μm to about 1500 μm, about 1000 μm to about 1400 μm, about 1050 μm to about 1400 μm, 1100 μm to about 1400 μm, about 1150 μm to about 1400 μm, 1200 μm to about 1400 μm, about 1250 μm to about 1400 μm, 1300 μm to about 1400 μm, about 1350 μm to about 1400 μm, about 1000 μm to about 1300 μm, about 1050 μm to about 1300 μm, 1100 μm to about 1300 μm, about 1150 μm to about 1300 μm, 1200 μm to about 1300 μm, about 1250 μm to about 1300 μm, about 1000 μm to about 1200 μm, about 1050 μm to about 1200 μm, 1100 μm to about 1200 μm, about 1150 μm to about 1200 μm, about 1000 μm to about 1100 μm, or about 1050 μm to about 1100 μm. In some embodiments, the mean pore size of the porous material is about 1000 μm to about 1500 μm. In some embodiments, the mean pore size of the porous material is about 1200 μm to about 1300 μm.

In some embodiments, the porous material comprises copper foam, graphite foam, stainless steel foam, titanium foam, nickel foam, silicon carbide foam, cobalt foam, polyurethane filled with graphite, boron nitride, metal powder, diamond powder, graphene, or a combination of any of them.

In some embodiments, the porous material is a copper foam.

In some embodiments, the porous material is a graphite foam.

In some embodiments, the porous material is a graphite/polyvinyl alcohol foam.

In some embodiments, the phase change material is selected from the group consisting of paraffin, polyethylene glycol, salt hydrate, and a fatty acid.

In some embodiments, the phase change material is a fatty acid; and the fatty acid is stearic acid.

In some embodiments, the phase change material is a paraffin; and the paraffin is octadecane.

In some embodiments, the polymer is selected from the group consisting of melamine-formaldehyde (MF) resin, polymethyl methacrylate (PMMA), urea-formaldehyde (UF), polystyrene (PS), polyurethane (PU), polyvinyl acetate, and melamine.

In some embodiments, the polymer is melamine.

In some embodiments, the phase change material is octadecane; and the polymer is melamine.

In some embodiments, the particles are about 10 wt. % to about 80 wt. %, about 20 wt. % to about 80 wt. %, about 30 wt. % to about 80 wt. %, about 40 wt. % to about 80 wt. %, about 50 wt. % to about 80 wt. %, about 60 wt. % to about 80 wt. %, about 70 wt. % to about 80 wt. %, about 10 wt. % to about 70 wt. %, about 20 wt. % to about 70 wt. %, about 30 wt. % to about 70 wt. %, about 40 wt. % to about 70 wt. %, about 50 wt. % to about 70 wt. %, about 60 wt. % to about 70 wt. %, about 10 wt. % to about 60 wt. %, about 20 wt. % to about 60 wt. %, about 30 wt. % to about 60 wt. %, about 40 wt. % to about 60 wt. %, about 50 wt. % to about 60 wt. %, about 10 wt. % to about 50 wt. %, about 20 wt. % to about 50 wt. %, about 30 wt. % to about 50 wt. %, about 40 wt. % to about 50 wt. %, about 10 wt. % to about 40 wt. %, about 20 wt. % to about 40 wt. %, about 30 wt. % to about 40 wt. %, about 10 wt. % to about 30 wt. %, about 20 wt. % to about 30 wt. %, or about 10 wt. % to about 20 wt. % of the phase change mixture. In some embodiments, the particles are about 10 wt. % to about 80 wt. % of the phase change mixture. In some embodiments, the particles are about 40 wt. % to about 60 wt. % of the phase change mixture.

In some embodiments, the particles are about 10 wt. %, about 20 wt. %, about 30 wt. %, about 40 wt. %, about 50 wt. %, about 60 wt. %, about 70 wt. %, or about 80 wt. % of the phase change mixture. In some embodiments, the particles are about 60 wt. % of the phase change mixture.

In some embodiments, the mean size of the particles is about 10 μm to about 50 μm, about 10 μm to about 45 μm, about 10 μm to about 40 μm, about 10 μm to about 35 μm, about 10 μm to about 30 μm, about 10 μm to about 25 μm, about 10 μm to about 20 μm, about 10 μm to about 15 μm, about 15 μm to about 50 μm, about 15 μm to about 45 μm, about 15 μm to about 40 μm, about 15 μm to about 35 μm, about 15 μm to about 30 μm, about 15 μm to about 25 μm, about 15 μm to about 20 μm, about 20 μm to about 50 μm, about 20 μm to about 45 μm, about 20 μm to about 40 μm, about 20 μm to about 35 μm, about 20 μm to about 30 μm, about 20 μm to about 25 μm, about 25 μm to about 50 μm, about 25 μm to about 45 μm, about 25 μm to about 40 μm, about 25 μm to about 35 μm, about 25 μm to about 30 μm, about 30 μm to about 50 μm, about 30 μm to about 45 μm, about 30 μm to about 40 μm, about 30 μm to about 35 μm, about 35 μm to about 50 μm, about 35 μm to about 45 μm, about 35 μm to about 40 μm, about 40 μm to about 50 μm, about 40 μm to about 45 μm, or about 45 μm to about 50 μm. In some embodiments, the mean size of the particles is about 15 μm to about 30 μm.

In some embodiments, the phase change mixture is about 50 vol. % to about 95 vol. %, about 55 vol. % to about 95 vol. %, about 60 vol. % to about 95 vol. %, about 65 vol. % to about 95 vol. %, about 70 vol. % to about 95 vol. %, about 75 vol. % to about 95 vol. %, about 80 vol. % to about 95 vol. %, about 85 vol. % to about 95 vol. %, about 90 vol. % to about 95 vol. %, about 50 vol. % to about 90 vol. %, about 55 vol. % to about 90 vol. %, about 60 vol. % to about 90 vol. %, about 65 vol. % to about 90 vol. %, about 70 vol. % to about 90 vol. %, about 75 vol. % to about 90 vol. %, about 80 vol. % to about 90 vol. %, about 85 vol. % to about 90 vol. %, about 50 vol. % to about 85 vol. %, about 55 vol. % to about 85 vol. %, about 60 vol. % to about 85 vol. %, about 65 vol. % to about 85 vol. %, about 70 vol. % to about 85 vol. %, about 75 vol. % to about 85 vol. %, about 80 vol. % to about 85 vol. %, about 50 vol. % to about 80 vol. %, about 55 vol. % to about 80 vol. %, about 60 vol. % to about 80 vol. %, about 65 vol. % to about 80 vol. %, about 70 vol. % to about 80 vol. %, about 75 vol. % to about 80 vol. %, about 50 vol. % to about 75 vol. %, about 55 vol. % to about 75 vol. %, about 60 vol. % to about 75 vol. %, about 65 vol. % to about 75 vol. %, about 70 vol. % to about 75 vol. %, about 50 vol. % to about 70 vol. %, about 55 vol. % to about 70 vol. %, about 60 vol. % to about 70 vol. %, about 65 vol. % to about 70 vol. %, about 50 vol. % to about 65 vol. %, about 55 vol. % to about 65 vol. %, about 60 vol. % to about 65 vol. %, about 50 vol. % to about 60 vol. %, about 55 vol. % to about 60 vol. %, about 50 vol. % to about 55 vol. % of the composite material. In some embodiments, the phase change mixture is about 60 vol. % to about 95 vol. % of the composite material. In some embodiments, the phase change mixture is about 70 vol. % to about 80 vol. % of the composite material.

In some embodiments, the present disclosure relates to a method of making the composite material disclosed herein, comprising:
a) heating the phase change mixture to a temperature above its melting temperature, thereby producing a liquid phase change mixture;
b) contacting the porous material with the liquid phase change mixture; and
c) applying vacuum to the porous material, thereby producing the composite material.

In some embodiments, the method further comprises sonicating the liquid phase change mixture prior to step b).

In some embodiments, in step a) the phase change mixture is heated at about 50-70° C. In some embodiments, in step a) the phase change mixture is heated at about 60° C.

In some embodiments, in step c) the porous material is heated at about 50-70° C. and the vacuum is applied for about 3-5 hours. In some embodiments, in step c) the porous material is heated at about 60° C. and the vacuum is applied for about 4 hours.

In some embodiments, during the sonication the liquid phase change mixture is heated at about 50-70° C. and the sonication occurs for about 10 min to about 2 hours. In some embodiments, during the sonication the liquid phase change mixture is heated at about 60° C. and the sonication occurs for about 30 minutes.

In some embodiments, the present disclosure relates to a method of constructing a building capable of passive cooling or heating, comprising constructing the building using a building material, wherein the building material comprises the composite material of the disclosure.

In some embodiments, the building material further comprises plasterboard, concrete, or insulation, or a combination of any of them.

In some embodiments, the present disclosure relates to a method of maintaining unchanging temperature of goods during transport, comprising transporting the goods in proximity to the composite material of the disclosure. As used herein, the term “in proximity” refers to two objects being within less than 20 of each other, e.g., less than 18 meters, less than 15 meters, less than 10 meters, less than 8 meters, less than 6 meters, less than 4 meters, less than 3 meters, less than 2 meters, less than 1 meter, less than 50 centimeters, less than 25 centimeters, or less than 10 centimeters from each other. In some embodiments, two objects in proximity to each other are touching each other.

In some embodiments, the goods are selected from the group consisting of food, beverage, and a pharmaceutical product, or a combination of any of them.

In some embodiments, the present disclosure relates to a method preventing overheating of a device, comprising contacting the device with the composite material of the disclosure.

In some embodiments, the device is an electronic device, a battery, or a combination of any of them.

In some embodiments, the present disclosure relates to a method of increasing efficiency of a device, comprising contacting the device with the composite material of the disclosure.

In some embodiments, the device is a solar water heater, a solar still, or a photovoltaic thermal (PVT) system.

### EXAMPLES

### Materials and Methods

The copper foam was purchased from Xiamen Zopin New Material Limited, while the graphite foam (CFOAM® 35) was obtained from CFOAM, LLC, with their properties listed in Table 2. High-purity (99%) n-octadecane paraffin was supplied by Thermo Scientific. Octadecane-encapsulated microparticles (MicroPCM 28D), featuring a melamine resin shell and an n-octadecane paraffin core with a mean particle size of 15-30 μm, were sourced from Microtek Laboratories, as detailed in Table 3.

TABLE 2
Physical properties of graphite and copper foams

| | Density | | Mean pore size |
|---|---|---|---|
| Type | (g/cm3) | Porosity | (μm) |
| CFOAM ® 35 | 0.40-0.50 | >70% | 1200 |
| Copper Foam | >0.1 | 90% | 1270 |

TABLE 3
Thermal properties of PCM and OEM

| | Density | Latent heat of fusion | Melting Temperature |
|---|---|---|---|
| Type | (g/cm3) | (J/g) | (°C) |
| Octadecane [42] | 0.814 | 244 | 27.5-28 |
| MicroPCM 28D | 0.9 | 181 | 26-30 |

The microstructures of the OEM mixtures and foam-based CPCMs were analyzed using a field emission scanning electron microscope (JEOL 7401F). Thermal conductivity was measured at room temperature (21° C.) using the TPS 2500s (Hot Disk® Instrument) with an accuracy of 5%. To minimize contact resistance, the sample surfaces were polished with sandpaper before testing. Latent heat was measured using a Differential Scanning calorimeter (DSC 25, TA Instruments) with a heating/cooling rate of 5° C./min, within a temperature range of 10° C. to 50° C. Each sample was measured three times to ensure accurate analysis.

The impregnation ratio of the foam-based CPCMs was calculated by measuring the weight change of foams before and after the impregnation process. The thermal stability of the OEM mixtures under melting was evaluated by observing the shape changes with a camera (Allied Vision, Model: Mako G). The leakage was evaluated by comparing the weight changes after multiple solidification and liquefaction cycles.

### Example 1. Preparation of OEM Mixtures and Foam-Based CPCMs

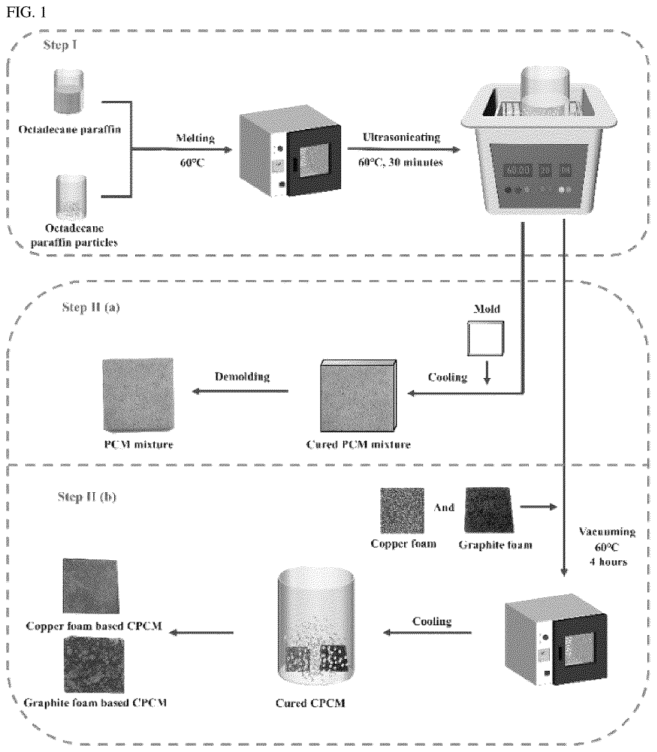

The preparation procedure for the octadecane and OEM (MicroPCM 28D) mixtures included the following steps (see FIG. 1): 1) MicroPCM 28D was blended in octadecane at mass fractions of 10%, 20%, 30%, 40%, 50% and 60% and the mixtures were then heated to 60° C. until the mixtures were fully melted; 2) the mixtures were sonicated at 60° C. for 30 minutes using an ultrasonic cleaner (VWR® Symphony™) to ensure thorough mixing; 3) the mixtures were poured into a PLA mold fabricated with a 3D printer (Ultimaker, Model: Ultimaker 3) and the OEM mixtures were allowed to cool naturally; and 4) the solidified sample was removed from the mold and ready the testing.

After the OEM mixtures were made, the following preparation procedure was used for the foam-based CPCMs: 1) seven graphite foams and seven copper foams, measuring approximately 20 mm×20 mm×10 mm and 20 mm×20 mm×2 mm were submerged in the melted OEM mixtures and processed under a vacuum of approximately 800 Pa for 4 hours at 60° C. until complete impregnation was achieved; 2) the formed CPCMs were allowed to cool naturally until solidified; 3) the excess OEM mixtures were carefully removed from the surface of the foam components with a precision knife.

### Example 2. Characterization of the CPCMs

### Impregnation Analysis

The impregnation ratio of the OEM mixture in the copper and graphite foams was analyzed to assess the heat storage capacity of the CPCMs. Firstly, the densities of OEM mixtures corresponding to mass fractions were determined as follows:

$${ρ}_{mix} ( r ) = \frac{{ρ}_{oc} {ρ}_{pa}}{( r {ρ}_{oc} + ( 1 - r ) {ρ}_{pa} )} \qquad ( 1 )$$

Where ρ_{oc} and ρₚₐ represent the densities of octadecane (C18) and microparticles, respectively, and r denotes the mass fraction, and the results are shown in Table 4.

TABLE 4
Densities of OEM mixtures with varying mass fractions

| | Octa- | Micro- | Mass fraction | | | | | |
|---|---|---|---|---|---|---|---|---|
| | decane | particles | 10% | 20% | 30% | 40% | 50% | 60% |
| Density | 0.814 | 0.9 | 0.822 | 0.83 | 0.838 | 0.846 | 0.855 | 0.864 |
| (g/cm3) | | | | | | | | |

The impregnation ratio, defined as the volume fraction of the impregnated OEM mixture relative to the total volume, is given by:

$${φ}_{ini} ( r ) = \frac{{W}_{CPCM} ( r ) - {W}_{fo} ( r )}{{ρ}_{mix} ( r ) {V}_{tot} ( r )} \qquad ( 2 )$$

where W_{CPCM} is the total weight of the foam based CPCM, r represents the mass fraction of the OEM mixture, W_{fo} is the weight of the foam, Vₜₒₜ is the total volume of the CPCM, and ρₘᵢₓ donates the density of the mixture.

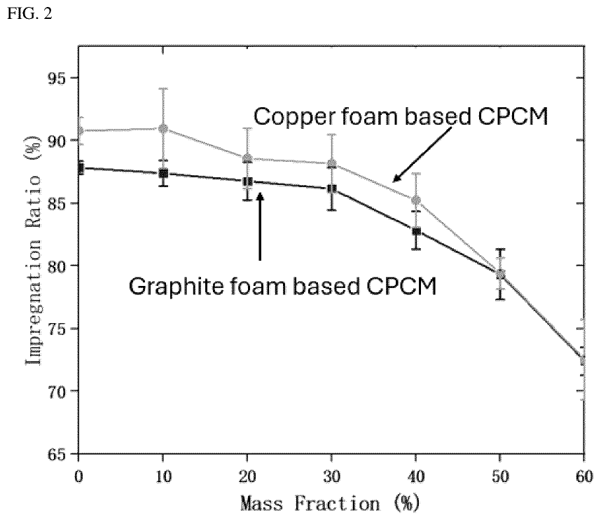

FIG. 2 illustrates the impregnation ratios of OEM mixtures embedded with copper and graphite foams under different mass fractions. The 90.8% of impregnation ratio for octadecane in copper foam is consistent with the copper foam porosity while the impregnation ratio in graphite foam reached 87.8%. As the mass fraction of OEM mixtures increases from 0% to 60%, the impregnation ratio decreases from 87.8% to 72.4% for graphite foam and from 90.8% to 72.5% for copper foam, with an uncertainty maintained within +4%.

It was observed that the impregnation ratio decreased in both copper and graphite foams as the OEM mixture concentration increased. This is attributed to the higher particle content, which increases the viscosity of the mixture, reduces the shear rate, and transforms the mixture into an emulsion-like state [43,44]. These conditions hinder the penetration of the OEM mixture into the foam structure, resulting in a reduced impregnation ratio at higher particle mass fractions.

The relationship between viscosity and volume fraction is described by Equation (3):

$${μ}_{mix} = {( 1 - \frac{∅}{{∅}_{max}} )}^{- B {∅}_{max}} \qquad ( 3 )$$

where B is taken as 5/2 for solid, spherical particles, while Ø and Øₘₐₓ represent the solid fraction and the maximum fraction of particles in the mixture, respectively. In previous studies, the product BØₘₐₓ was reported to range from 2 to 2.5 with Øₘₐₓ approximately 0.74 [43].

### Microstructure Analysis

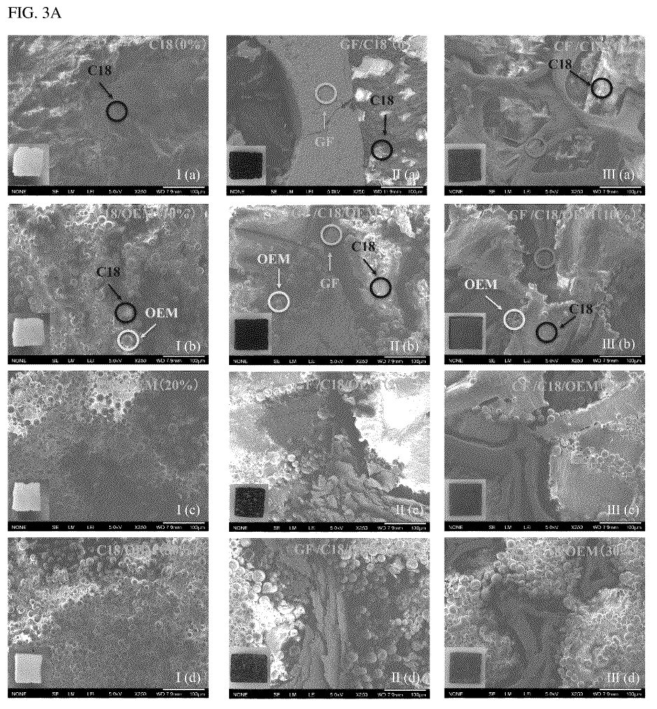

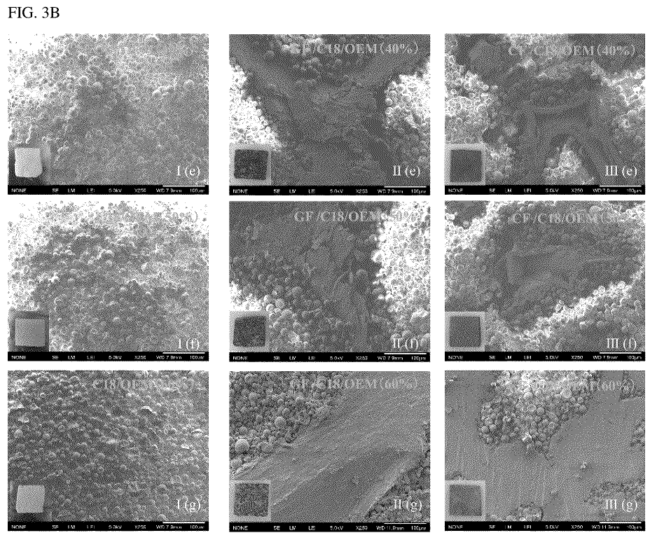

FIGS. 3A and 3B present the SEM images of the OEM mixtures and foam based CPCMs with the mass fraction of OEM mixtures ranging from 0% to 60%. FIG. 3A, panels I(a), II(a), and III(a) show the structures of octadecane and octadecane in graphite and copper foams. It can be seen that octadecane has a thin-sheet structure which is completely encapsulated within the pores of the foam. As the mass fraction increases from 0% to 60%, the thin sheet structure becomes interrupted by microparticles, as shown in FIGS. 3A and 3B, panels I(b-g), II(b-g), and III(b-g). At 60% mass fraction (FIG. 3B, panels I(g), II(g), and III(g)), the initial thin sheet structure is filled with densely packed spherical particles. As discussed below, this unique mixture structure results in a slurry-like macroscopic behavior which effectively slows down the leakage when the octadecane is melted to liquid.

### Thermal Conductivity Measurements

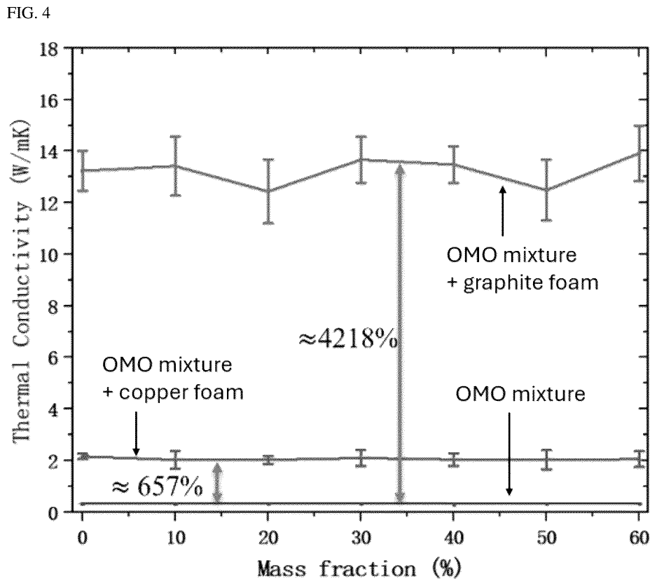

The thermal conductivity of the OEM based CPCMs was measured with the TPS 2500S (Hot Disk® Instrument). It should be pointed out that the thermal conductivities of pure octadecane, copper foam, graphite foam, copper foam/octadecane based CPCM, and graphite foam/octadecane based CPCM were measured as 0.33±0.014 W/m·K, 2.05±0.12 W/m·K, 13.11±0.81 W/m·K, 2.06±0.11 W/m·K and 13.17±0.77 W/m·K, respectively. FIG. 4 presents the thermal conductivity values of the OEM mixtures and foam-based CPCMs. The results show the thermal conductivity of the OEM mixtures varies between 0.32 W/m·K and 0.34 W/m·K, while the graphite foam-based CPCMs ranges between 12.44 W/m·K and 13.92 W/m·K and the copper foam-based CPCMs between 2.03 W/m·K and 2.17 W/m·K. Since C18 is the primary component of the OEM, variations in its mass fraction have a minimal impact on the overall thermal conductivity of the mixtures. Additionally, the thermal conductivity of graphite foam- and copper foam-based CPCMs is primarily determined by the thermal conductivity of the foams themselves, while the OEM mixtures have a negligible effect. This behavior aligns with the parallel model assumption used to calculate the effective thermal conductivity, as defined in Eqn. (4) [45]. When the thermal conductivity of the foam is significantly higher than that of the PCM, the overall thermal conductivity of the CPCM k_{CPCM} is dominated by the foam component.

k_{CPCM}=εkₘᵢₓ+(1−ε)k_{fo} (4)

where ε is the foam porosity, kₘᵢₓ and k_{fo} are the thermal conductivities of the OEM mixture and the foam, respectively.

Compared to the OEM mixtures, the copper foam based CPCMs increase thermal conductivity by approximately 6-fold, while the graphite foam based CPCMs achieve an improvement of about 40-fold. Moreover, compared to the copper foam based CPCMs, the graphite foam based CPCMs exhibit greater variability in thermal conductivity, attributed to the non-uniform pore size and irregular pore distribution.

### Analysis of Latent Heat and Supercooling

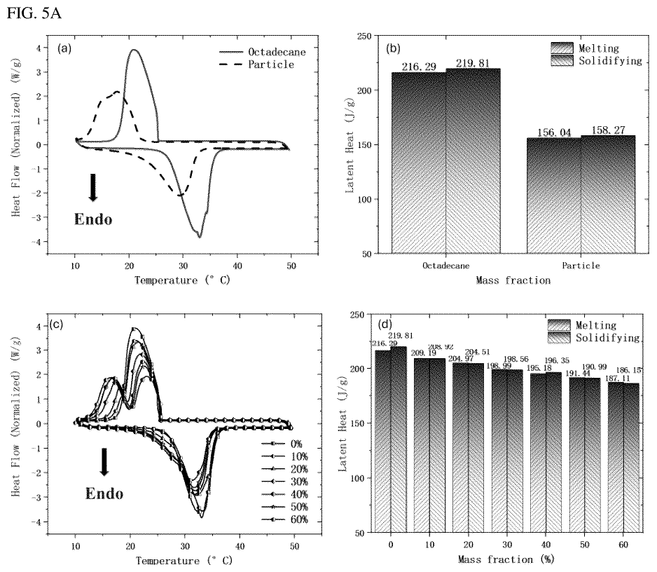

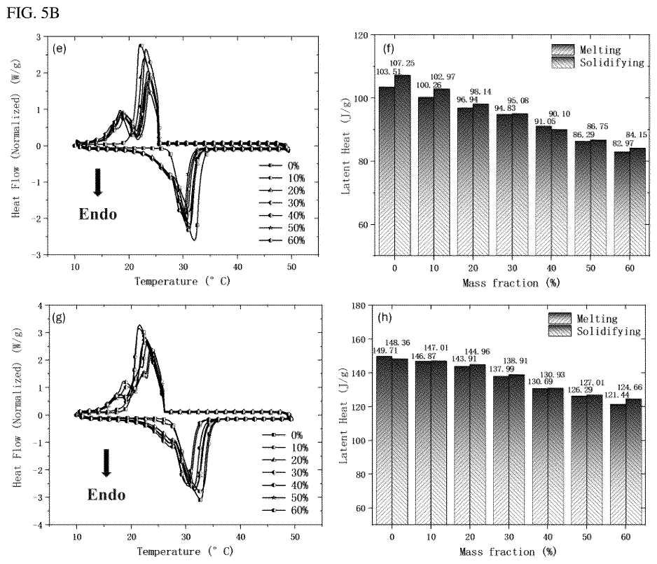

The latent heat and transition temperature of octadecane, OEM mixtures, and the foam-based CPCMs are presented in FIGS. 5A and 5B. It was found that due to the shell layer (melamine resin) effect, the latent heat of pure octadecane during the melting phase (ΔHm) decreases from 216.29 J/g to 156.04 J/g for the OEM while the latent heat during the solidifying phase (ΔHs) decreases from 219.81 J/g to 158.27 J/g. In addition, octadecane and the particles exhibit different transition temperatures shifting from 33.02° C. to 29.36° C. during melting and from 20.91° C. to 17.88° C. during solidification. Furthermore, due to the increasing proportion of OEM, which has a relatively low latent heat, the latent heat of OEM mixtures decreases from 216.29 J/g to 187.11 J/g during the melting process and from 219.81 J/g to 186.15 J/g during solidification as the mass fraction increases from 0% to 60%. After further impregnation into the foam-based structure, ΔHm and ΔHs further decreases. For graphite foam-based CPCMs, ΔHm decreases from 149.71 J/g to 121.44 J/g and ΔHs decreases from 148.36 J/g to 124.66 J/g while for copper foam-based CPCMs, ΔHm decreases from 103.51 J/g to 82.97 J/g and ΔHs decreases from 107.25 J/g to 84.15 J/g. This decrease is believed to be caused by the higher mass fraction of OEM and the lower impregnation ratio of the OEM mixtures. Moreover, due to the lower density of graphite foam, graphite foam-based CPCMs exhibit higher latent heat compared to copper foam.

It can also be observed that for both the OEM mixtures and the foam-based CPCMs, two peaks appear during solidification, which can be attributed to the different phase transition temperatures of C18 and OEM.

The subcooling degree for various mass fractions of the OEM mixtures is calculated based on the difference between the melting and freezing peak temperatures [46], as shown in FIG. 6. It was observed that increasing the particle mass fraction results in a smaller temperature difference, indicating a reduced degree of supercooling. This behavior is attributed to the greater number of particles serving as nucleating agents, which effectively promote crystallization and suppress supercooling. Consequently, the delay in latent heat release is minimized, leading to improved temperature stability and enhanced overall thermal performance.

### Analysis of the Shape Stability of OEM Mixtures

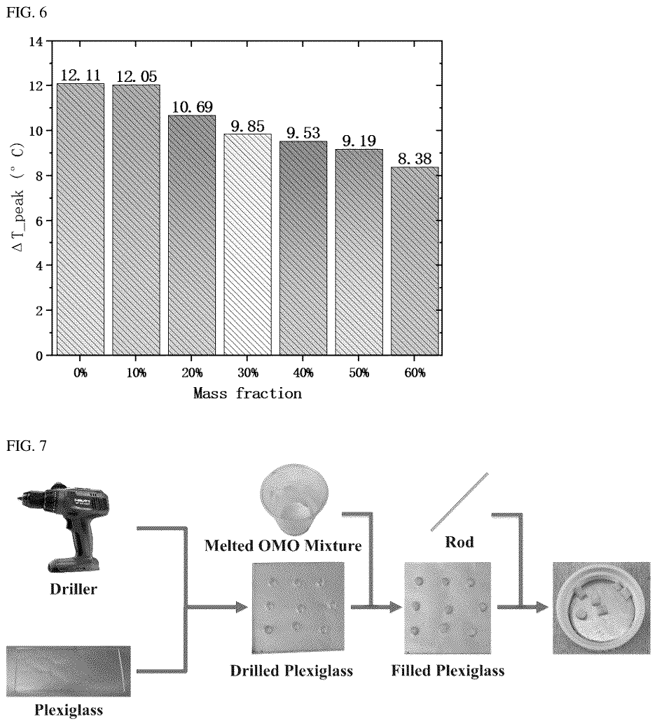

The flow behavior of the OEM mixtures during the phase change is critical for understanding the leakage of liquid octadecane and is examined by a unique OEM mixture heating method. The cylindrical OEM mixture samples with a diameter of 2 mm were prepared using the method illustrated in FIG. 7 including: 1) 2 mm in diameter holes were drilled through a 3 mm thick plexiglass sheet; 2) These holes were filled with the well-mixed, melted OEM mixture after ultrasonic processing and then cool naturally; 3) The residual of OEM mixture was removed from the sheet surface and the cylinder of OEM mixtures were demold from the holes by using a copper rod.

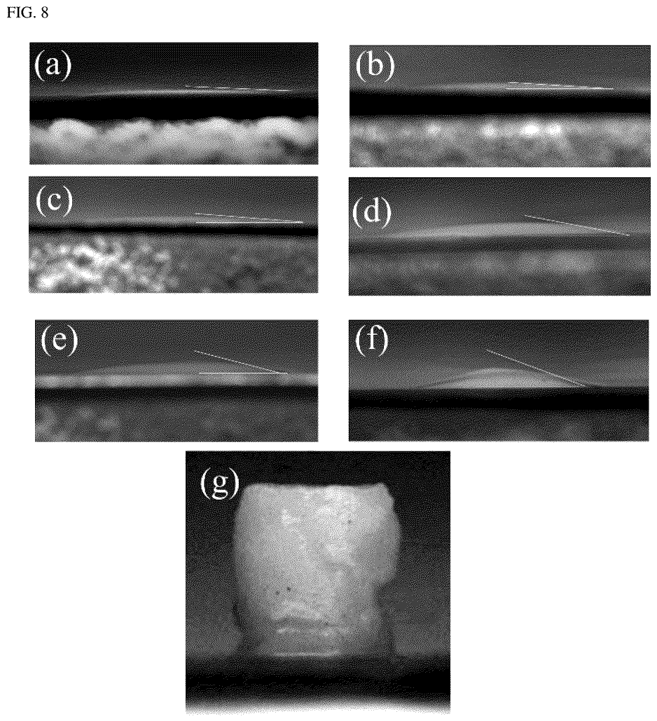

The flow behavior of the OEM mixture cylinders under the melting temperature was observed with an optical camera (Allied Vision, Model: Mako G). The test procedure is as follows: 1) the samples were placed on a flat copper sheet surface which was attached to a hot plate under room temperature; 2) the temperature of the copper sheet was gradually increased to 70° C. from room temperature by increasing the hot plate temperature; 3) Wait for 10 minutes and then the shape of the melted sample was recorded by the camera. The optical images of the OEM mixture cylinders during the melting process are shown in FIG. 8. In addition, the angles of the melted mixture and copper surface were measured using Image J and the results are presented in Table 5.

TABLE 5
The contact angle of the liquid OEM mixtures
on the surface of the copper sheet

| Mass fraction | 0% | 10% | 20% | 30% | 40% | 50% | 60% |
|---|---|---|---|---|---|---|---|
| Contact angle (°) | 2.7 | 3.9 | 8.5 | 10.7 | 12.9 | 14.4 | N/A |

It was observed that an increase in the mass fraction of the OEM mixture led to a corresponding increase in the contact angle of the melted mixture. Interestingly when the mass fraction reached 60%, the OEM mixture maintained its original shape even above the melting temperature. This phenomenon can be attributed to the increased particle concentration in the mixture, which enhances inter-particle interactions and promotes the formation of a spatial network structure. As a result, the OEM mixture exhibits non-Newtonian behavior, acting more like an elastic material with suppressed viscous dissipation [47]. When the particle concentration exceeds 60%, the mixture behaves increasingly like a viscoelastic solid, capable of maintaining its shape without flowing.

### Analysis of the Leakage of the Foam Based CPCMs

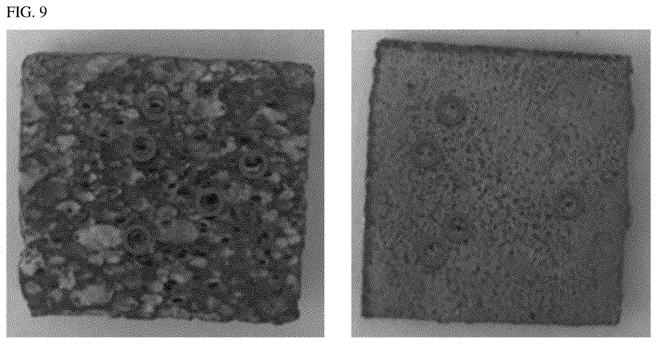

In the leakage analysis, the copper and graphite foam based CPCM samples with different mass ratio of OEM mixture were placed on a weighing paper and heated in an oven at 60° C. for 1 hour to ensure complete melting and stabilization. The samples were then allowed to cool naturally until the OEM mixture in the foams was solidified, the leaked OEM mixture was carefully removed using a precision knife, and the weight of the CPCM samples was recorded. This procedure was repeated four times to assess the leakage ratio over multiple melting and solidification cycles. FIG. 9 shows the surface images of the graphite foam and copper foam-based CPCMs after four thermal cycles. It is apparent that many voids appear on the sample surface which were originally filled with OEM mixture, an indication of the leakage.

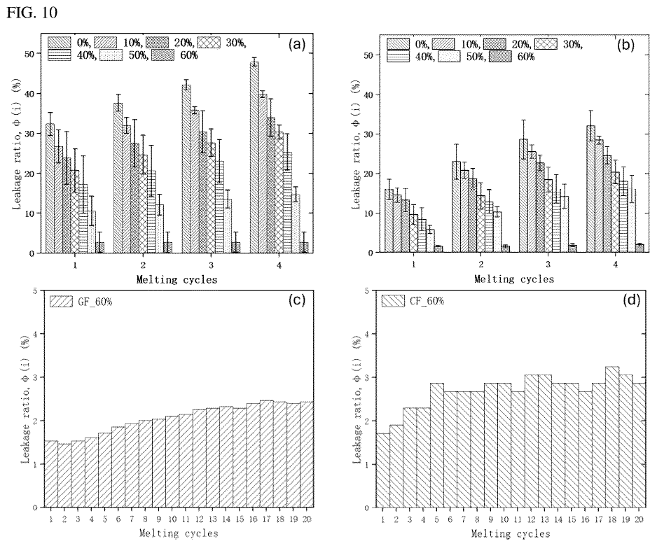

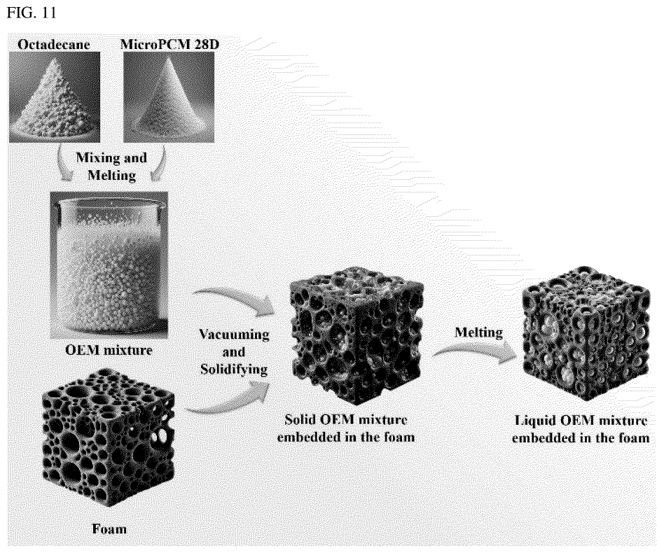

FIG. 10, panels (a) and (b) report the change in leakage ratio of OEM mixtures after the four melting/solidification cycles. A dimensionless leakage ratios of the OEM mixture remained in the foams after each melting/solidification cycle is introduced to evaluate the PCM leakage as:

$${φ}_{leak}^{i} ( r ) = \frac{{W}_{CPCM}^{0} ( r ) - {W}_{CPCM}^{i} ( r )}{{W}_{CPCM}^{0} ( r ) - {W}_{fo} ( r )} \qquad ( 5 )$$

where Wⁱ_{CPCM} and W_{fo} are the weight of the CPCM and foam, i represents the number of melting cycles, ranging from 1 to 4.

As can be seen, leakage ratio decreases are 47.96%, 39.88%, 33.98%, 30.37%, 25.38%, 14.77%, and 2.78% when the mass fraction of the OEM mixtures increases from 0% to 10%, 20%, 30%, 40%, 50%, and 60% for graphite-foam based CPCM. For the copper foam-based CPCMs, the corresponding ratios are 32.11%, 28.49%, 24.62%, 20.41%, 18.05%, 16.09%, and 1.98%. When the mass fraction of OEM mixture reaches 60%, the leakage of PCM is close to 0% or leakage-free. Furthermore, continuous melting-solidification cycles were conducted to evaluate the leakage situation of the foam-based CPCMs (60% weight ratio) for prolonged operation. As shown in FIG. 10, panels (c) and (d), the leakage ratios stabilized at approximately 3% for both the graphite-foam and copper foam-based CPCMs over 20 cycles, demonstrating excellent leakage resistance.

The measurement results are consistent with the previous shape stability analysis. As the OEM mass concentration increases, the viscosity increases, and the mixture starts exhibiting non-Newtonian behavior due to enhanced inter-particle interactions [47]. At the mass fraction of 60%, the mixture behaviors like a viscoelastic solid which effectively prevents the flow during the melting of the mixture. In addition, the volume expansion resulting from the melting of the PCM (C18) is believed to be accommodated by the tiny voids within the foam structure, as illustrated in FIG. 11. As shown in FIG. 2, the OEM mixture with a 60% mass fraction occupies only about 72.5% of the graphite based and copper-based foam volume, leaving roughly 27.5% as voids. These voids accommodate the ~15% volume expansion of PCM during liquefaction [48], thereby mitigating the risk of leakage caused by thermal expansion.

A novel composite phase change material (CPCM) composed of octadecane, and octadecane-encapsulated microparticles was developed to improve the thermal conductivity and reduce the leakage of PCM during the phase change process. The thermal properties of the copper foam based CPCMs demonstrated a 6-fold increase in thermal conductivity and a 40-fold enhancement for the graphite foam based CPCMs. In the meantime, the graphite foam based CPCMs exhibits 1.5× increase in latent heat compared to the copper foam based CPCMs. In addition, the measurements show reduced supercooling and leakage with increasing mass fractions of OEM mixtures. The non-Newtonian behavior of liquid OEM mixtures is the main reason for low leakage of developed CPCM.

### REFERENCES

1. G. Alva, L. Liu, X. Huang, G. Fang, Thermal energy storage materials and systems for solar energy applications, Renewable and Sustainable Energy Reviews 68 (2017) 693-706,
2. X. Xiang, R. Yang, N. A. Tehrani, H. Sun, “Advanced topology design of cold plate for battery operating under dynamic conditions,” International Journal of Heat and Mass Transfer, 256 (2026), pp. 128054.
3. X. Xiang, R. Yang, R. Nagarajan, H. Sun. A new battery thermal management system with integrated phase change materials and cold plate: a numerical study, HT (2022) 81860,
4. H. Zhu, X. Xiang, X. Zhang, H. Liu, H. Zhang, H. Sun, Y. Zheng, Analysis of Hybrid Thermal Systems Incorporating Composite Phase Change Materials, ASME Open J. Engineering, 4 (2025) 041017.
5. H. Q. Nguyen, B. Shabani, Metal hydride thermal management using phase change material in the context of a standalone solar-hydrogen system, Energy Conversion and Management 224 (2020) 113352.
6. C. Xu, H. Zhang, G. Fang, Review on thermal conductivity improvement of phase change materials with enhanced additives for thermal energy storage, Journal of Energy Storage 51 (2022) 104568.
7. F. Chen, M. Wolcott, Polyethylene/paraffin binary composites for phase change material energy storage in building: A morphology, thermal properties, and paraffin leakage study, Solar Energy Materials & Solar Cells 137 (2015) 79-85.
8. C. Su, X. Xiang, H. Esmaeilzadeh, J. Wang, E. Fratto, M. Charmchi, Z. Gu, H. Sun, A new composite phase change material for thermal energy storage, IMECE2019-10457.
9. C. Su, X. Xiang, J. Wang, E. Fratto, M. Charmchi, Z. Gu, H. Sun, Simulation of large-scale magnetic manipulation of micro/nanomaterial based on monte carlo method, IMECE2020-24052.
10. M. Aramesh, B. Shabani, Metal foam-phase change material composites for thermal energy storage: A review of performance parameters, Renewable and Sustainable Energy Reviews 155 (2022) 111919.
11. R. Akula, A. Minnikanti, C. Balaji, Pin fin-PCM composite heat sink solution for thermal management of cylindrical Li-ion battery, Applied Thermal Engineering 248 (2024) 123146.
12. Y. Han, Y. Yang, T. Mallick, C. Wen, Nanoparticles to enhance melting performance of phase change Materials for thermal energy storage, Nanomaterials 12 (2022), 1864.
13. X. K. Yu, Y. B. Tao, Preparation and characterization of paraffin/expanded graphite composite phase change materials with high thermal conductivity, International Journal of Heat and Mass Transfer 198 (2022) 123433.
14. M. Caliano, N. Bianco, G. Graditi, L. Mongibello, Analysis of a phase change material-based unit and of an aluminum foam/phase change material composite-based unit for cold thermal energy storage by numerical simulation, Applied Energy 256 (2019) 113921.
15. H. Senobar, M. Aramesh, B. Shabani, Nanoparticles and metal foams for heat transfer enhancement of phase change materials: A comparative experimental study, Journal of Energy Storage 32 (2020) 101911.
16. A. M. Elshaer, A. M. A. Soliman, M. Kassab, S. Mori, A. A. Hawwash, Experimental investigations on copper foam/PCM composite-based thermal control hardware (TCH) using foam samples with different pore sizes under intermittent thermal conditions, Journal of Energy Storage 72 (2023) 108320.
17. Z. Sun, Y. Guo, C. Zhang, J. Whitehouse, Q. Zhou, H. Xu, C. Wang, Experimental study of battery passive thermal management system using copper foam-based phase change materials, International Journal of Thermofluids 17 (2023) 100255.
18. G. Muhammad, Z. Yao, Y. Chen, Q. Xia, C. Yang, Experimental investigation on thermal performance of phase change materials-metal foam composites in ocean thermal engine, Case Studies in Thermal Engineering 60 (2024) 104693.
19. X. K. Yu, Y. B. Tao, Y. He, Z. C. Lv, Preparation and performance characterization of metal foam/paraffin/single-walled carbon nanotube composite phase change material, International Journal of Heat and Mass Transfer 191 (2022) 122825.
20. X. Xiang, R. Yang, H. Sun, D. Hoffman, Performance improvement of a hybrid battery thermal management system with pseudo-3D topology optimization, International Journal of Heat and Mass Transfer 240 (2025) 126632.
21. X. Xiang, A. M. Routsi, R. Nagarajan, Q. Wang, R. Yang, I. C. Esfahani, D. Hoffman, H. Sun, Numerical and experimental investigation of a hybrid battery thermal management system for high-rate applications, Journal of Energy Storage 141 (2026) 119081.
22. M. Das, U. Stachewicz, 3D carbon based phase change composites: A review on progress in fabrication strategies, thermal energy storage-conversion efficacy, prototypes, numerical models and applications, Journal of Energy Storage 98 (2024) 113029.
23. S. Li, T. Yan, Y. Huo, W. Pan, Carbon nanotube/carbon foam thermal-bridge enhancing solar energy conversion and storage of phase change materials, Materials Today Sustainability 28 (2024) 100986.
24. X. Yang, C. Li, Y. Ma, H. Chi, Z. Hu, J. Xie, High thermal conductivity of porous graphite/paraffin composite phase change material with 3D porous graphite foam, Chemical Engineering Journal 473 (2023) 145364.
25. B. K. Choure, T. Alam, R. Kumar, A review on heat transfer enhancement techniques for PCM based thermal energy storage system, Journal of Energy Storage 72 (2023) 108161.
26. B. Buonomo, M. R. Golia, O. Manca, S. Nardini, A review on thermal energy storage with phase change materials enhanced by metal foams, Thermal Science and Engineering Progress 53 (2024) 102732.
27. M. Aramesh, B. Shabani, Metal foams application to enhance the thermal performance of phase change materials: A review of experimental studies to understand the mechanisms, Journal of Energy Storage 50 (2022) 104650.
28. H. Li, R. Y. Tay, S. H. Tsang, R. Hubert, P. Coquet, T. Merlet, J. Foncin, J. J. Yu, E. H. T. Teo, Thermally conductive and leakage-proof phase-change materials composed of dense graphene foam and paraffin for thermal management, ACS Appl. Nano Mater. 5 (2022) 8362 8370.
29. C. Pan, P. He, J. Wu, N. Chen, J. Wei, T. Xu, E. Shi, A. Wang, H. Jia, Copper foam effectively improves the thermal performance of graphene-aerogel composite phase-change materials for thermal storage, Journal of Energy Storage 51 (2022) 104485.
30. T. Jiang, J. Hu, S. Wu, D. Shen, P. Lu, A shape-stable phase change material for high-temperature thermal energy storage based on coal fly ash and Na₂SO₄—K₂SO₄, Solar Energy 280 (2024) 112868.
31. M. Zhang, B. Quan, P. Chen, Y. Yang, C. Ding, S. Liu, H. Wu, X. Hu, X. Lu, Large-scale preparation of leakage-proof phase change composites with compressed enhanced thermally conductive network for efficient thermal management, Journal of Energy Storage 83 (2024) 110725.
32. K. Palraj, D. Shanmugavel, Development of form-stable natural composite phase change material for effective thermal energy storage and anti-leakage behaviour, Journal of Energy Storage 84 (2024) 110692.
33. P. Kumar, S. Thomas, C. B. Sobhan, G. P. Peterson, Activated carbon foam composite derived from PEG400/Terminalia Catappa as form stable PCM for sub-zero cold energy storage, Journal of Cleaner Production 434 (2024) 139993.
34. F. Ma, Y. Liang, Z. Tao, X. Guo, Q. Guo, Z. Liu, A novel PCM/expanded graphite composite sphere with high thermal conductivity and excellent shape stability used for a packed-bed thermal energy system, Diamond & Related Materials 145 (2024) 111102.
35. A. M. Nair, C. Wilson, B. Kamkari, J. Locke, M. Huang, P. Griffiths, N. J Hewitt, Advancing Thermal Performance in PCM-Based Energy Storage: A Comparative Study with Fins, Expanded Graphite, and Combined Configurations, Energy Conversion and Management: X 23 (2024) 100627.
36. R. Fan, N. Zheng, Z. Sun, Enhanced photothermal conversion capability of melamine foam-derived carbon foam-based form-stable phase change composites, Energy Conversion and Management 263 (2022) 115693.
37. Y. Zhou, Y. Cao, H. Chen, R. Wu, H. Cheng, F. Luo, Q. Qian, Q. Chen, Q. Lin, Three-dimensional continuous network graphite nanosheets-based carbon foam supported stearic acid as effective shape-stabilized phase change material, Journal of Energy Storage 59 (2023) 106575.
38. Y. Xie, Y. Yang, Y. Liu, S. Wang, X. Guo, H. Wang, D. Cao, Paraffin/polyethylene/graphite composite phase change materials with enhanced thermal conductivity and leakage-proof, Advanced Composites and Hybrid Materials 4 (2021) 543-551.
39. W. Mei, W. Zheng, J. Zeng, T. Bi, Q. Lin, Y. Zhou, Mesoporous surface dual-scale carbon foam/stearic acid composite as desirable shape-stabilized phase change material with excellent thermal storage and photo-thermal conversion performance, Journal of Energy Storage 100 (2024) 113642.
40. S. Nishad, Z. Ahmad, I. Krupa, Enhancement of photovoltaic module performance by thermal management using shape-stabilized PCM composites, Solar Energy Materials & Solar Cells 273 (2024) 112948.
41. M. Liu, S. Zhang, Y. Shi, Z. Fang, J. Wang, C. Bao, Highly thermally conductive and shape-stabilized phase change materials with desirable solar/electric-to-thermal conversion performance based on high-modulus graphite/PVA foam, Chemical Engineering Journal 499 (2024) 156509.
42. J. Hirschey, k. R. Gluesenkamp, a. Mallow, s. Graham, Review of Inorganic Salt Hydrates with Phase Change Temperature in Range of 5° C. to 60° C. and Material Cost Comparison with Common Waxes, 5th International High Performance Buildings Conference, 320.
43. B. J. Konijn, O. B. J. Sanderink, N. P. Kruyt, Experimental study of the viscosity of suspensions: Effect of solid fraction, particle size and suspending liquid, Powder Technology 266 (2014) 61-69.
44. K. Dutkowski, J. J. Fiuk, Experimental investigation of the effects of mass fraction and temperature on the viscosity of microencapsulated PCM slurry, International Journal of Heat and Mass Transfer 126 (2018) 390-399.
45. T. Rehman, H. M. Ali, M. M. Janjua, U. Sajjad, W. Yan, A critical review on heat transfer augmentation of phase change materials embedded with porous materials/foams, International Journal of Heat and Mass Transfer 135 (2019) 649-673.
46. A. Mustapha, Y. Wang, Y. Ding, Y. Li, Supercooling elimination of cryogenic-temperature microencapsulated phase change materials (MPCMs) and the rheological behaviors of their suspension, Journal of materials research and technology 21 (2022) 2277-2295.
47. A. Ya. Malkin, Non-Newtonian viscosity in steady-state shear flows, Journal of Non-Newtonian Fluid Mechanics 192 (2013) 48-65.
48. J. S. Lee, S. Lucyszyn, Design and pressure analysis for bulk-micromachined electrothermal hydraulic microactuators using a PCM, Sensors and Actuators A 133 (2007) 294-300.

### INCORPORATION BY REFERENCE

All U.S. and PCT patent application publications and U.S. patents cited herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A composite material, comprising a porous material impregnated with a phase change mixture; wherein:
the phase change mixture comprises a phase change material and a plurality of particles; and
each particle in the plurality of particles comprises a core and a shell; wherein the core is within the shell; the core comprises the phase change material; and the shell comprises a polymer.

2. The composite material of claim 1, wherein the porosity of the porous material is greater than about 70%.

3. (canceled)

4. The composite material of claim 1, wherein the mean pore size of the porous material is about 1000 μm to about 1500 μm.

5. (canceled)

6. The composite material of claim 1, wherein the porous material comprises copper foam, graphite foam, stainless steel foam, titanium foam, nickel foam, silicon carbide foam, cobalt foam, polyurethane filled with graphite, boron nitride, metal powder, diamond powder, graphene, or a combination of any of them.

7. The composite material of claim 6, wherein the porous material is a copper foam, a graphite foam, or a graphite/polyvinyl alcohol foam.

8.-9. (canceled)

10. The composite material of claim 1, wherein the phase change material is selected from the group consisting of paraffin, polyethylene glycol, salt hydrate, and a fatty acid.

11. The composite material of claim 10, wherein the phase change material is a fatty acid; and the fatty acid is stearic acid.

12. The composite material of claim 10, wherein the phase change material is a paraffin; and the paraffin is octadecane.

13. The composite material of claim 1, wherein the polymer is selected from the group consisting of melamine-formaldehyde (MF) resin, polymethyl methacrylate (PMMA), urea-formaldehyde (UF), polystyrene (PS), polyurethane (PU), polyvinyl acetate, and melamine.

14. The composite material of claim 1, wherein the polymer is melamine.

15. The composite material of claim 1, wherein the phase change material is octadecane; and the polymer is melamine.

16. The composite material of claim 1, wherein the particles are about 10 wt. % to about 80 wt. % of the phase change mixture.

17. (canceled)

18. The composite material of claim 1, wherein the mean size of the particles is about 15 μm to about 30 μm.

19. The composite material of claim 1, wherein the phase change mixture is about 60 vol. % to about 95 vol. % of the composite material.

20. (canceled)

21. A method of making the composite material of claim 1, comprising:
a) heating the phase change mixture to a temperature above its melting temperature, thereby producing a liquid phase change mixture;
b) contacting the porous material with the liquid phase change mixture; and
c) applying vacuum to the porous material, thereby producing the composite material.

22. The method of claim 21, further comprising sonicating the liquid phase change mixture prior to step b).

23.-25. (canceled)

26. A method of constructing a building capable of passive cooling or heating, comprising constructing the building using a building material, wherein the building material comprises the composite material of claim 1.

27. (canceled)

28. A method of maintaining unchanging temperature of goods during transport, comprising transporting the goods in proximity to the composite material of claim 1.

29. (canceled)

30. A method of preventing overheating of a device, comprising contacting the device with the composite material of claim 1.

31. (canceled)

32. A method of increasing efficiency of a device, comprising contacting the device with the composite material of claim 1.

33. (canceled)
